(19) United States
(12) Patent Application Publication
(10) Pub. No.: US 2009/0249320 A1
(43) Pub. Date: Oct. 1, 2009

(54) Display Control Device Capable of Automatically Updating Firmware and Method Thereof

(75) Inventors: CHAO PING SU, Hsinchu Hsien (TW); MING HONG HUANG, Hsinchu Hsien (TW); CHIH CHIEH LEE, Hsinchu Hsien (TW); KUN NAN CHENG, Hsinchu Hsien (TW)

Correspondence Address: WPAT, PC, 7225 BEVERLY ST., ANNANDALE, VA, 22003, US

(73) Assignee: MSTAR SEMICONDUCTOR, INC., Hsinchu Hsien (TW)

(21) Appl. No.: 12/372,956

(22) Filed: Feb. 18, 2009

(30) Foreign Application Priority Data
Apr. 1, 2008 (TW) 097111807

(51) Int. Cl. G06F 9/44

(52) U.S. Cl. 717/168

(57) ABSTRACT

A display control device with automatic firmware update and an update method thereof are provided to update the firmware of the display control device rapidly and automatically, thereby improving user convenience and reducing user waiting time. The display control device comprises a transmission interface unit, a memory interface unit, a non-volatile memory interface unit, a first direct memory access (DMA) unit, a second DMA unit and a controller. The transmission interface unit is coupled to a code-providing unit for providing an updated code of the firmware. After detecting that the transmission interface unit is coupled to the code-proving unit, the controller automatically and temporarily stores the updated code provided by the code-providing unit into a dynamic random access memory (DRAM), and further writes the updated code into a non-volatile memory from the DRAM, thereby accomplishing automatic update of the firmware of the display control device.

### FIELD OF THE INVENTION

The present invention relates to a display control device, and more particularly, to a display control device capable of automatically updating firmware and method thereof.

### BACKGROUND OF THE INVENTION

Professional technicians are needed in operating devices and special software for updating firmware for a conventional display control device, such as a monitor or a television. It is hard for end users to proceed firmware update. For example, to update the firmware for a monitor with a VGA connector, a professional technician needs to bring a laptop and connects a printer port from the laptop to the VGA connector of the monitor via an I2C adaptor circuit board. A special program is executed on the laptop and codes are written into the monitor for updating the firmware. The procedure is rather time consuming and inconvenient.

### SUMMARY OF THE INVENTION

In view of the foregoing issues, one object of the invention is to provide a display control device capable of automatically updating firmware and method thereof, so as to update the firmware of the display control device automatically.

Another object of the invention is to provide a display control device capable of automatically updating firmware and an update method thereof, so as to update the firmware of the display control device quickly and reduce user waiting time.

The present invention discloses a display control device capable of automatically updating firmware. The device comprises a transmission interface unit, a memory interface unit, a non-volatile memory interface unit, a first direct memory access (DMA) unit, a second DMA unit and a controller. The transmission interface unit is coupled to a code-providing unit for providing an updated code of the firmware. After detecting that the transmission interface unit is coupled to the code-providing unit, the controller automatically and temporarily stores the updated code provided by the code-providing unit into a dynamic random access memory (DRAM), and further writes the updated code to the non-volatile memory, thereby accomplishing automatic firmware update of the display control device.

The present invention further discloses a method of automatically updating a firmware for a display control device, comprising steps of detecting an automatic firmware update event; reading the updated code of the firmware from a code-providing unit by the display control device, and temporarily storing the updated code into a memory in response to the automatic firmware update event; and writing the updated code stored in the memory into a non-volatile memory, thereby accomplishing automatic firmware update of the display control device.

### BRIEF DESCRIPTION OF THE DRAWINGS

FIG. 1 shows a block diagram of a display control device capable of automatically updating firmware in accordance with a preferred embodiment of the invention.

FIG. 2 shows a flow chart of an update method of a display control device capable of automatically updating firmware in accordance with a preferred embodiment of the invention.

### DETAILED DESCRIPTION OF THE PREFERRED EMBODIMENT

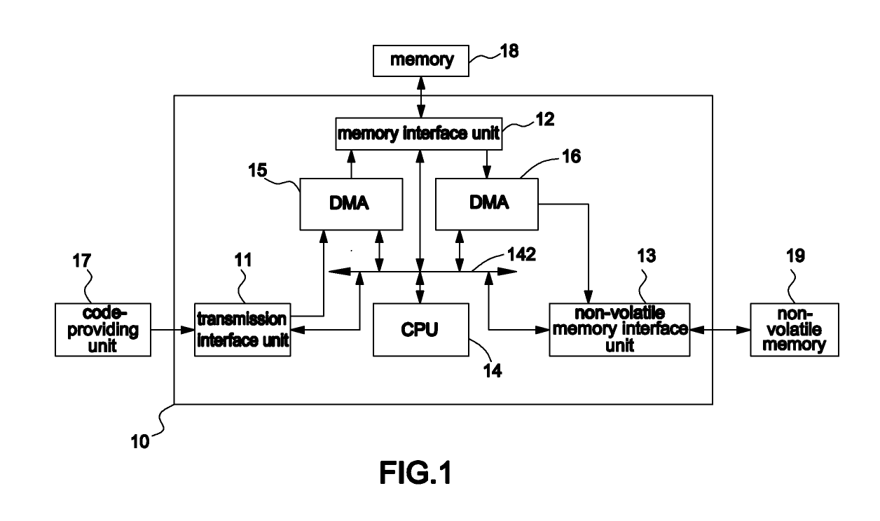

FIG. 1 shows a block diagram of a display control device 10 capable of automatically updating firmware in accordance to a preferred embodiment of the present invention. The display control device 10 comprises a transmission interface unit 11, a memory interface unit 12, a non-volatile memory interface unit 13, a central processing unit (CPU) 14, a direct memory access (DMA) unit 15 and a DMA unit 16. The display control device 10 can be applied in monitors, televisions and digital photo frames. The transmission interface unit 11 is externally coupled to a code-providing unit 17 which stores an updated code of the firmware of the display control device 10. For example, the CPU 14 can be an 8051 microprocessor or an ARM processor. The memory interface unit 12 is coupled to a memory 18 which can be a dynamic random access memory (DRAM) or a static random access memory (SRAM), so as to provide a high speed access. The non-volatile memory interface unit 13 is coupled to a non-volatile memory 19 which can be a flash memory or an electrically erasable programmable read-only memory (EEPROM), so as to non-volatily store the firmware of the display control device 10. The non-volatile memory interface unit 13, for example, is a Serial Peripheral Interface (SPI). The CPU 14 executes the firmware of the display control device 10. The CPU 14 programs the DMA unit 15 via a bus 142, quickly transmits data in DMA mode from the code-providing unit 17 to the memory interface unit 12 via the transmission interface unit 11 and temporarily stores the same in the memory 18. The CPU 14 programs the DMA unit 16 via the bus 142 to quickly transmit data in DMA mode from the memory 18 to the non-volatile memory 19 via the memory interface unit 12 and the non-volatile memory interface unit 13.

In this embodiment, after the transmission interface unit 11 is coupled to the code-providing unit 17, the CPU 14 determines whether a file with a predetermined filename is stored in the code-providing unit 17. When the predetermined filename is present in the code-providing unit 17, the CPU 14 decides whether to update the firmware by examining whether the contents of the file match a predetermined format. For example, the CPU 14 recognizes a predetermined header in the file in the predetermined filename in order to initiate the firmware update. The file with the predetermined filename further comprises associated information for firmware update, such as the number of bytes of the updated code of the firmware and the storage address in the non-volatile memory 19 to which the updated code is written. The update file of the firmware can be transmitted according to a communication protocol between the display control device 10 and the code-providing unit 17. When detecting that the file with the predetermined filename exists and matches the predetermined format, the CPU 14 programs the DMA units 15 and 16 to start data transfer. The DMA unit 15 quickly transfers the updated code from the code-providing unit 17 via the transmission interface unit 11 to the memory 18 via the memory interface unit 12 for temporary storage. Then, the DMA unit 16 quickly writes the updated code temporarily stored in the memory 18 into the non-volatile memory 19. By DMA units 15 and 16, the whole updated code is successively transmitted without involving the CPU 14 to divide the updated code into multiple small data pieces to be transmitted one by one. Thus, the firmware updating process is significantly accelerated. Preferably, the whole firmware update process is automatically accomplished after the code-providing unit 17 is coupled to the display control device 10, without further user operations, thereby enhancing user convenience.

Various kinds of transmission interfaces can be applied by the transmission interface unit 11 for data transmission. In this embodiment, the transmission interface unit 11 is a universal serial bus (USB) host interface, and the code-providing unit 17 is a USB portable disk. To update the firmware of the display control device 10, a user just needs to plug the USB portable disk storing the firmware code to an USB connector (not shown) on the display control device 10. The firmware update process is thus accomplished. In another embodiment, a transmission interface unit 11 is a flash memory card interface, and the code-providing unit 17 is a flash memory card. A user may couple the flash memory storing the firmware code to the display control device 10 to accomplish the firmware update. Alternatively, a transmission interface unit 11 can be a wireless transmission interface or a wired network interface, such as a Bluetooth interface or a coaxial cable interface. When the present invention is applied to televisions and the wired network interface is the coaxial cable interface, the code-providing unit 17 can be a remote server of a cable television provider. The cable television provider at a remote location can provide a firmware update service of televisions for all customers via the coaxial cable. In the application of the wireless transmission or the wired network, a firmware update command can be transmitted. The CPU 14 decodes the firmware update command and programs the DMA units 15 and 16 respectively, so as to initiate the firmware update of the display control device 10.

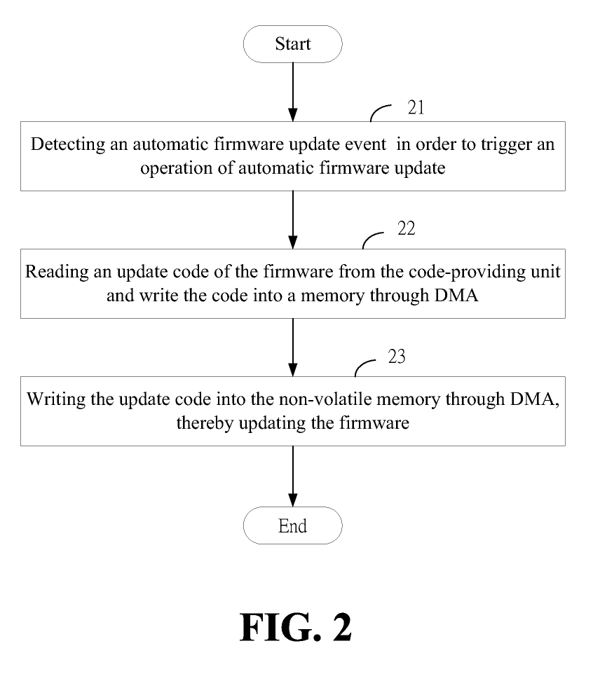

FIG. 2 shows a flow chart of automatically updating a firmware of a display control device in accordance with a preferred embodiment of the invention. The display control device can be applied to monitors, televisions or digital photo frames. An original firmware of the display control device is stored in a non-volatile memory, e.g. a flash memory or an EEPROM. In Step 21, an automatic firmware update event is detected in order to trigger an operation of automatic firmware update. For example, when a code-providing unit is coupled to the display control device, contents of a file with a predetermined filename in the code-providing unit are checked to determine whether the contents match a predetermined format. For example, the file contains a predetermined header in order to generate the automatic firmware update event. Alternatively, the current invention can also be capable of detecting whether wired or wireless transmission information contains a firmware update command in order to generate the automatic firmware update event. In Step 22, read an updated code of the firmware from the code-providing unit and write the code into a memory through DMA by the display control device. For example, the memory is a DRAM or an SRAM. In Step 23, write the updated code, temporarily stored in the memory, into the non-volatile memory through DMA by the display control device, thereby updating the firmware. The display control device can be coupled to the code-providing unit through various kinds of transmission interfaces, such as a USB interface, a flash memory card interface, a wireless transmission interface, e.g. Bluetooth, a wired network interface, e.g. a coaxial cable interface or an RJ-45 interface, etc.

To sum up, the present invention discloses a display control device capable of automatically updating firmware. The display control device comprises a transmission interface unit, a memory interface unit, a non-volatile memory interface unit, a first DMA unit, a second DMA unit and a controller, e.g. a CPU. The transmission interface unit is coupled to a code-providing unit for providing an updated code of the firmware. After detecting that the transmission interface unit is coupled to the code-providing unit, the controller automatically and temporarily stores the updated code provided by the code-providing unit into a DRAM, and then writes the updated code into the non-volatile memory so as to accomplish the firmware update of the display control device.

The present invention discloses a method of automatically updating a firmware for a display control device, comprising steps of detecting an automatic firmware update event, reading an updated code of the firmware by the display control device from a code-providing unit and temporarily storing the updated code into a memory in response to the automatic firmware update event, and writing the updated code of the firmware temporarily stored in the memory into a non-volatile memory by the display control device, thereby accomplishing automatic firmware update of the display control device.

The foregoing preferred embodiment illustrates the present invention in detail, however the invention needs not to be limited to the above embodiment. Various modifications will be apparent to persons skilled in the art within the spirit and scope of the appended claims which are to be accorded with the broadest interpretation so as to encompass all such modifications and similar structures.

What is claimed is:

1. A display control device capable of automatically updating a firmware, comprising:
a transmission interface unit for coupling to a code-providing unit stored with an updated code of the firmware;
a volatile memory interface unit for coupling to a volatile memory;
a non-volatile memory interface unit for coupling to a non-volatile memory;
a first direct memory access (DMA) unit, coupled to the transmission interface unit and the volatile memory interface unit;
a second DMA unit, coupled to the non-volatile memory interface unit and the volatile memory interface unit; and
a controller, coupled to the transmission interface unit, the volatile memory interface unit, the non-volatile memory interface unit, the first DMA unit and the second DMA unit;
wherein, after the controller detects that the transmission interface unit is coupled to the code-providing unit, the controller temporarily stores the updated code of the firmware to the volatile memory through the first DMA unit and then writes the updated code of the firmware temporarily stored in the volatile memory into the non-volatile memory through the second DMA unit.

2. The display control device as claimed in claim 1, wherein the non-volatile memory is a flash memory or an electrically erasable programmable read-only memory (EEPROM).

3. The display control device as claimed in claim 1, wherein the volatile memory is a dynamic random access memory (DRAM) or a static random access memory (SRAM).

4. The display control device as claimed in claim 1, wherein the transmission interface unit is a universal serial bus (USB) interface.

5. The display control device as claimed in claim 4, wherein the code-providing unit is a USB portable disk.

6. The display control device as claimed in claim 1, wherein the transmission interface unit is a flash memory card interface.

7. The display control device as claimed in claim 1, wherein the transmission interface unit is a wireless transmission interface or a wired network interface.

8. The display control device as claimed in claim 1, wherein the code-providing unit stores a file with a predetermined filename, after the transmission interface unit is coupled to the code-providing unit, the controller detects whether the file with the predetermined filename match a predetermined format so as to generate an automatic firmware update event for automatically writing the updated code into the non-volatile memory.

9. The display control device as claimed in claim 1, wherein the controller is an 8051 microprocessor or an ARM processor.

10. The display control device as claimed in claim 1, wherein the non-volatile memory interface unit is a Serial Peripheral Interface (SPI).

11. A method of automatically updating a firmware for a display control device, comprising:
detecting an automatic firmware update event;
reading an updated code of the firmware by the display control device from a code-providing unit and temporarily storing the updated code of the firmware into a volatile memory in response to the automatic firmware update event; and
writing the updated code of the firmware temporarily stored in the volatile memory into a non-volatile memory by the display control device.

12. The method as claimed in claim 11, wherein the non-volatile memory is a flash memory or an EEPROM.

13. The method as claimed in claim 11, wherein the volatile memory is a DRAM or an SRAM.

14. The method as claimed in claim 11, wherein the display control device is coupled to the code-providing unit via a USB interface.

15. The method as claimed in claim 14, wherein the code-providing unit is a USB portable disk.

16. The method as claimed in claim 11, wherein the display control device is coupled to the code-providing unit via a wireless transmission interface or a wired network interface.

17. The method as claimed in claim 11, wherein the display control device resides in a monitor, a television or a digital photo frame.

18. The method as claimed in claim 11, wherein the display control device automatically writes the updated code into the non-volatile memory through DMA.

19. The method as claimed in claim 11, wherein the detecting step detects whether a file with a predetermined filename stored in the code-providing unit matches a predetermined format when the code-providing unit is coupled to the display control device.

20. The method as claimed in claim 11, wherein the detecting step detects whether transmission data from the code-providing unit contains a firmware update command when the code-providing unit is coupled to the display control device.
